(19) United States
(12) Patent Application Publication
(10) Pub. No.: US 2002/0087968 A1
(43) Pub. Date: Jul. 4, 2002

(54) Set-top box with credit card reader and method of activation/authentication

(76) Inventors: Aditya Krishnan, San Diego, CA (US); Matthew S. Chang, San Diego, CA (US); Andrew M. Proehl, San Francisco, CA (US); David K. L. Yang, San Jose, CA (US); Fred J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/753,111

(22) Filed: Jan. 2, 2001

(51) Int. Cl. H04N 7/16; H04N 7/173

(52) U.S. Cl. 725/6; 725/133; 725/140

(57) ABSTRACT

A television set-top box incorporates a swipe card reader for reading credit cards, debit cards or automated teller cards or the like. A credit card can be activated by swiping the credit card through the set-top box credit card reader to automatically initiate a process of activation of the card with a remote server serving as an activation center or clearing house. Moreover, the card reader can be used to simplify on-line purchases from merchants over the Internet or for interfacing with a credit card authority to manage the user's credit card account.

### FIELD OF THE INVENTION

This invention relates generally to the field of television set-top boxes. More particularly, this invention relates to a television set-top box having an associated swipe card reader and methods therefor.

### BACKGROUND OF THE INVENTION

Television set-top boxes were initially introduced to provide tuning capabilities for cable and satellite television systems. While these devices still provide that fundamental function, digital set-top boxes now often incorporate powerful computers in the latest generation of set-top boxes. With such computers available, it is now possible to expand the usefulness of the television set-top box beyond that of merely providing tuning functions for cable and satellite systems.

### SUMMARY OF THE INVENTION

The present invention relates generally to a television set-top with an associated swipe-card reader. Objects, advantages and features of the invention will become apparent to those skilled in the art upon consideration of the following detailed description of the invention.

In one embodiment consistent with the present invention, a television set-top box incorporates a swipe card reader for reading credit cards, debit cards, automated teller cards or the like. A credit card can be activated by swiping the credit card through the set-top box credit card reader to automatically initiate a process of activation of the card with a remote server serving as an activation center or clearing house. Moreover, the card reader can be used to simplify on-line purchases from merchants over the Internet or for interfacing with a credit card authority to manage the user's credit card account.

A television set-top box according to certain embodiments of the invention includes a tuner for receiving signals representing television programming and delivering the signals representing television programming to a display interface. The set-top box further includes a central processor. A communication device, operatively coupled to the central processor, sends and receives data over a communication medium. A swipe card reader is operatively coupled to the central processor to receive data from a swipe card passed through the swipe card reader.

A method of activating a swipe card using a set-top box having a swipe card reader associated therewith according to embodiments of the invention includes: reading a magnetic stripe on the swipe card using the swipe card reader; using communications capabilities of the set-top box, transmitting information read from the swipe card to an authority authorized to activate the swipe card; and using communications capabilities of the set-top box, transmitting authentication information to the authority authorized to activate the swipe card.

A method, according to certain embodiments of the invention, of carrying out a swipe card transaction using a television set-top box includes: receiving a swipe card passed through a swipe card reader associated with the set-top box to read data associated with the swipe card; retrieving authenticating information from a storage device associated with the set-top box; and transmitting the data associated with the swipe card and the authenticating information using a communication device associated with the set-top box to a recipient.

According another embodiment, a storage medium storing instructions which, when executed on a programmed processor, carry out a process of activating a swipe card using a set-top box having a swipe card reader associated therewith includes: reading a magnetic stripe on the swipe card using the swipe card reader; using communications capabilities of the set-top box, transmitting information read from the swipe card to an authority authorized to activate the swipe card; and using communications capabilities of the set-top box, transmitting authentication information to the authority authorized to activate the swipe card.

According to yet another embodiment, a storage media storing instructions which, when executed on a programmed processor, carry out a method of carrying out a swipe card transaction using a television set-top box includes: receiving a swipe card passed through a swipe card reader associated with the set-top box to read data associated with the swipe card; retrieving authenticating information from a storage device associated with the set-top box; and transmitting the data associated with the swipe card and the authenticating information using a communication device associated with the set-top box to a recipient.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a flow chart describing one embodiment of a process of activation and use of a credit card with a set-top box consistent with the present invention.

FIG. 4 is an illustration of the higher layers of a menu hierarchy used in a method consistent with the present invention.

FIG. 5, which is made up of FIG. 5A, FIG. 5B and FIG. 5C, is a flow chart of actions taken as a result of menu selections available in the menus of FIG. 4 excluding navigational selections.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

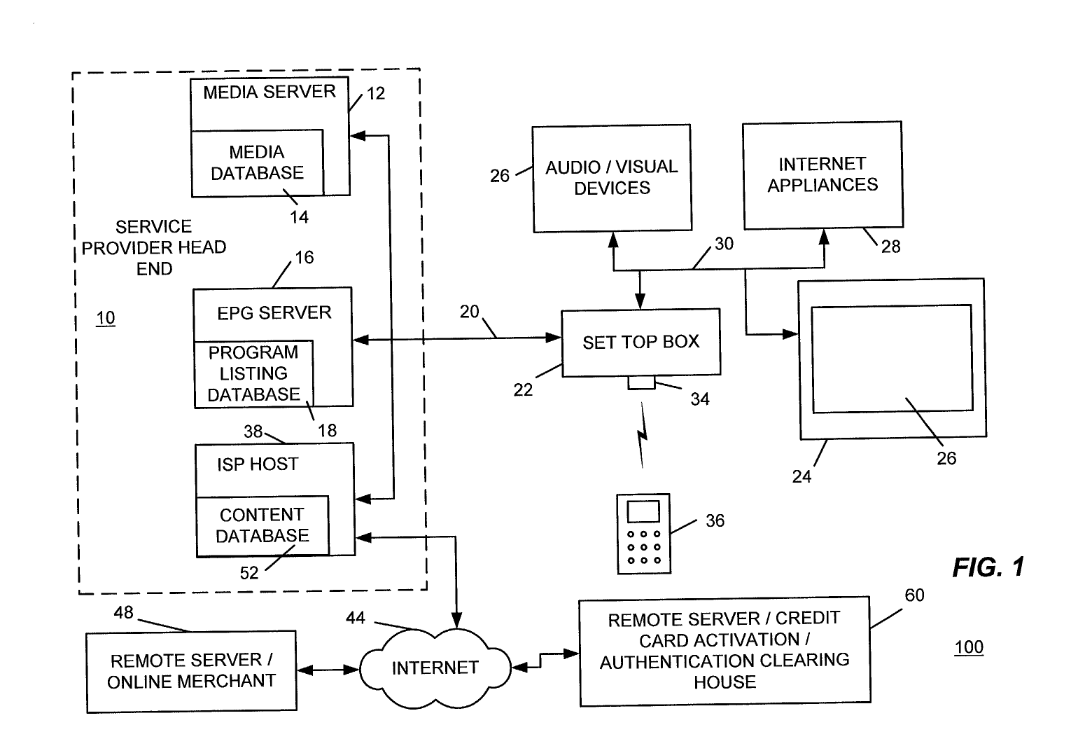

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface-Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio-visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

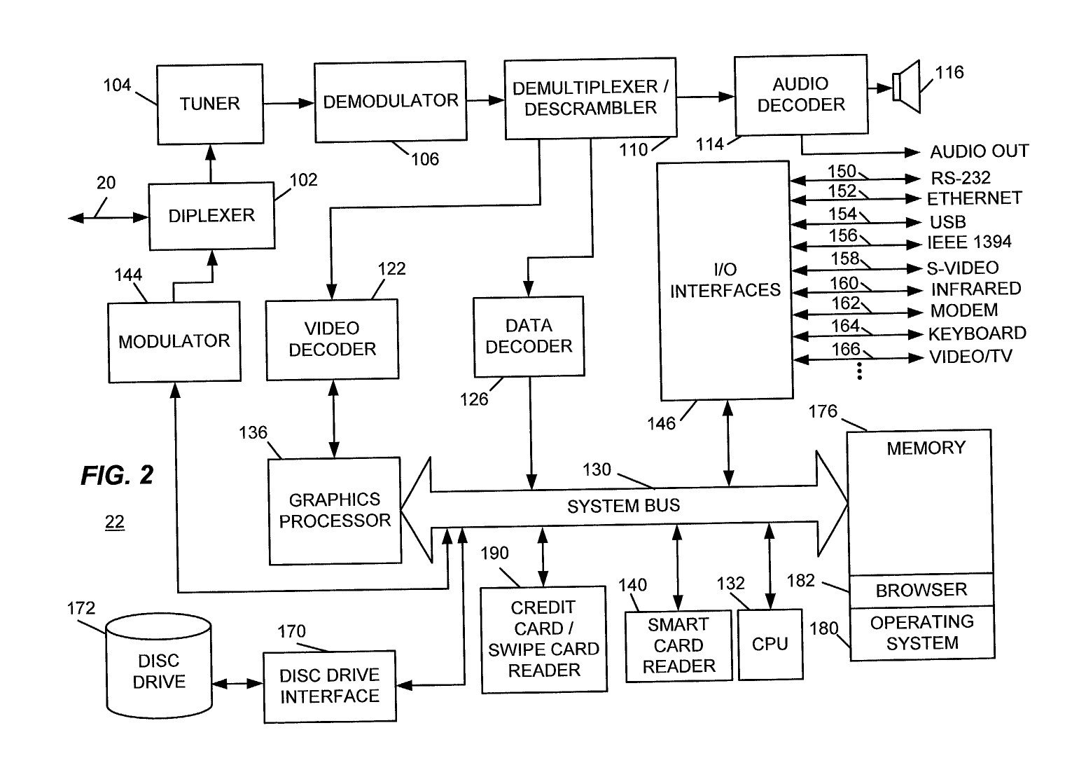

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user. Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio /visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer 1 descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD RAW drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

Referring back to FIG. 1, in accordance with embodiments of the present invention, the STB 22 may communicate through the service provider 10 and the Internet 44 to remote server 48, which may be an online merchant, so that the user can make online purchases. In addition, the STB 22 may communicate with a remote server 60 serving as a credit card activation/authentication clearing house (or other credit card authority), as will become clear from the following discussion. While the present invention is illustrated in terms of the remote server 60, the credit card activation/authentication clearing house or other credit card authority could be situated at the service provider 10 in certain embodiments. In other embodiments, the credit card authority (e.g., bank, department store, merchant or credit card company) can substitute equivalently for the credit card activation I authentication clearing house, without departing from the invention.

In accordance with embodiments of the present invention, the set-top box 22 of FIG. 2 includes a credit card reader or swipe card reader 190—that is, a card reader for reading a magnetic swipe card such as a credit card or debit card. While this credit card reader 190 is illustrated as an integral part of STB 22, the present invention can also be realized with a separate external credit card reader coupled to a suitable interface 146. In the context of the present invention, the terms “credit card ” and “swipe card” are used to generically and equivalently describe a credit card, debit card, automated teller card, smart card or other card using conventional magnetic stripe encoding or magnetic stripe interface. The present invention also contemplates use of future “electronic purse” type devices that can operate, from a user's perspective, in a similar manner as a credit card to permit purchases via a line of credit or by debiting an account. All such devices are considered equivalent herein and will be referred to using the common terms “credit card” or “swipe card.” In a similar manner, smart-card reader 140 can be considered equivalent to credit card reader 190 to the extent that the smart card read by reader 140 can be used for purchases of goods and services in a manner similar to that used online with a credit card.

The present invention contemplates use of STB 22 to facilitate online activation of the credit card and to facilitate purchases and other transactions by providing the user with the ability to conveniently input credit card information in the familiar manner of use of a swipe card (or other card interface mechanism) and to provide authentication functions for the card.

With a set-top box 22 incorporating a credit card or other swipe card reader 190, the set-top box can be utilized for a multitude of new functions. Since the set-top box and associated swipe card reader 190 are presumably situated within a secure location in the user's home, use of the user's credit card or other card in conjunction with swipe card reader 190 of set-top box 22 provides an automatic level of authentication that the user is, in fact, who he is portrayed to be. That notwithstanding, the use of personal identification codes entered through an input device such as remote control 36 (or a keyboard, etc.) and the like in conjunction with a swipe card used in swipe card reader 190 can still be used to provide a more secure form of authenticating the owner of the card.

In one embodiment of the present invention, the swipe card reader 190 in conjunction with set-top box 22 can be used to activate a newly received credit card. In another embodiment of the present invention, the user's existing credit card can be utilized to carry out on-line transactions or otherwise interact with a credit card authority such as remote server 60 to manage the credit card account. In yet another embodiment, an automated teller card can be utilized to conduct certain banking functions in a more secure manner using the home set-top box 22.

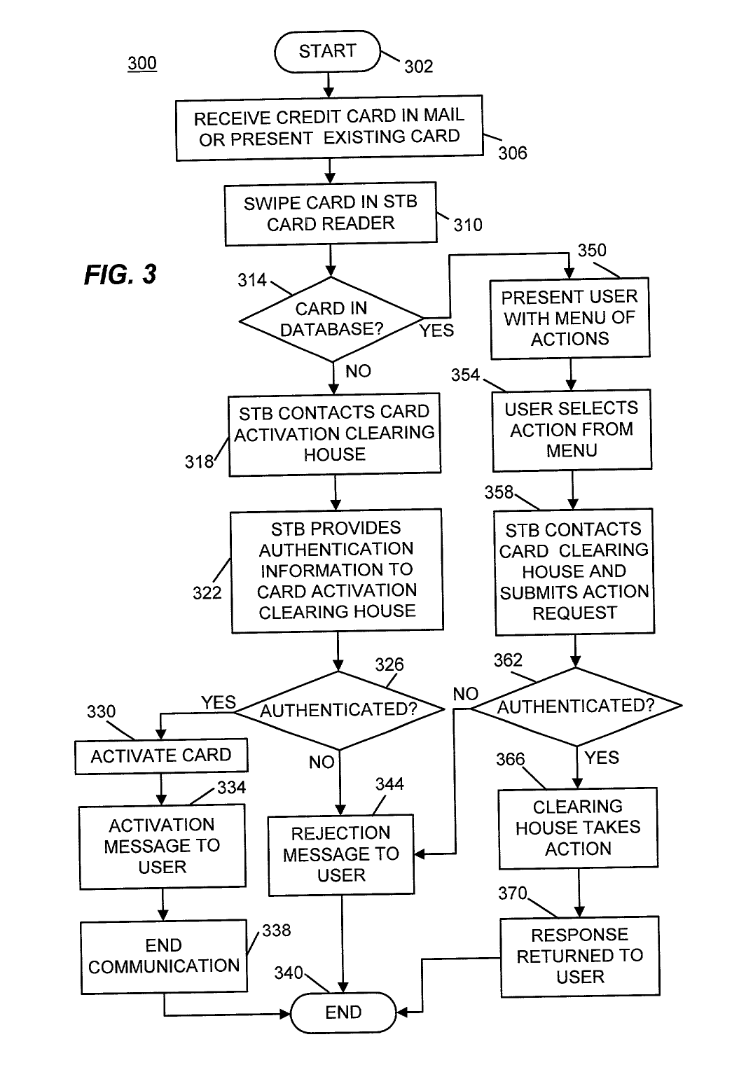

Referring now to FIG. 3, a process 300 for utilizing a swipe card reader 190 of set-top box 22 in accordance with the present invention is illustrated. The process starts at 302. At 306, a user either receives a new credit card in the mail or retrieves an exiting credit card in order to carry out a transaction. At 310, the credit card is swiped through card reader 190 of set-top box 22 and the card reader 190 reads the magnetic stripe encoded information on the credit card. In accordance with the present embodiment, central processor 132 inspects the information received from swiped card reader 190 at 314 to determine if there is a record of this particular credit card in a credit card database stored in an encrypted manner, for example on disc drive 172 or other non-volatile storage. If not, it can be presumed that the user wishes to activate a new card.

Thus, at 318 the set-top box contacts the card activation clearing house 60 by using an internal modem such as a DOCSIS modem to connect with remote server 60 through service provider 10 and Internet 44. The set-top box then provides authentication information to the credit card activation clearing house 60 at 322. This authentication information includes, in the current example, the credit card identifying information as well as information that identifies the owner of the credit card by virtue of use of set-top box 22, and may also include personal identification numbers either entered as part of the process or previously entered and stored in the STB 22's storage. If multiple users are registered with set-top box 22, it is, of course, likely that the user should identify himself to the set-top box prior to or after swiping the card through the card reader at 310.

Upon receipt of the information at the remote server 60, the credit card activation authentication clearing house 60 authenticates the credit card at 326 to determine whether or not the card should be activated. If so, the card is activated at 330 and a message is sent to the user via set-top box 22 for display on display 26 at 334. The communication channel is terminated and the communication ends at 338. The process of activating the card is thus completed and the process ends at 340. If the user is not authenticated at 326, a rejection message is sent to the user at 344 for display on display 26 and the process again ends at 340. Thus, the user is able to quickly activate a newly received credit card by simply approaching a set-top box within his home and swiping the card. As previously mentioned, it may be advantageous to provide additional safeguards such as requiring the user to enter specific identifying information such as a personal identification number or other secret information to provide a more secure authentication.

If at 314, the CPU 132 determines, under program control, that the credit card swiped at 310 in card reader 190 is, in fact, in the database of credit cards, then the user is presented with a menu of actions at 350 according to this embodiment. (In other embodiments, the menu can be retrieved in another manner with the card being swiped afterward without departing from the invention.) Depending on the nature of the card, the banking institution, etc., many possibilities exist for the actions that can be taken in accordance with the menu presented at 350. An example will be provided later, but this example is not to be considered limiting in view of the many possibilities for actions.

At 354, the user selects an action from the menu by, for example, navigating through the menu with remote controller 36 and pointing to menu selections by highlighting them and selecting the menu selection by, for example, an enter key on the remote controller 36. In other embodiments, a mouse and keyboard or other input devices can be utilized to make the appropriate selections. Once a selection is made at 354, the set-top box contacts the credit card clearing house 60 and submits a request for the particular action associated with the menu selection at 358. At 362, an authentication process is again carried out to assure that the user is in fact authorized to carry out the transaction being requested. If not, a rejection message 344 is generated and the process terminates at 340. However, assuming that the user is authenticated at 362, the clearing house takes the appropriate action at 366 and returns a response to the user at 370. The process then terminates at 340.

Those skilled in the art will recognize that many variations of process 300 can be implemented without departing from the basic teachings of the present invention. In addition, although the present invention is described in conjunction with use of a credit card activation and authentication clearing house located on a remote server and contacted through the Internet, other arrangements are possible wherein, for example, the clearing house is situated at the service provider 10 (or the service provider 10 serves as the clearing house). In another embodiment, a banking institution or other issuer of the credit card may be contacted directly as opposed to use of a clearing house arrangement. These and other variations are contemplated and considered equivalent within the scope of the present invention.

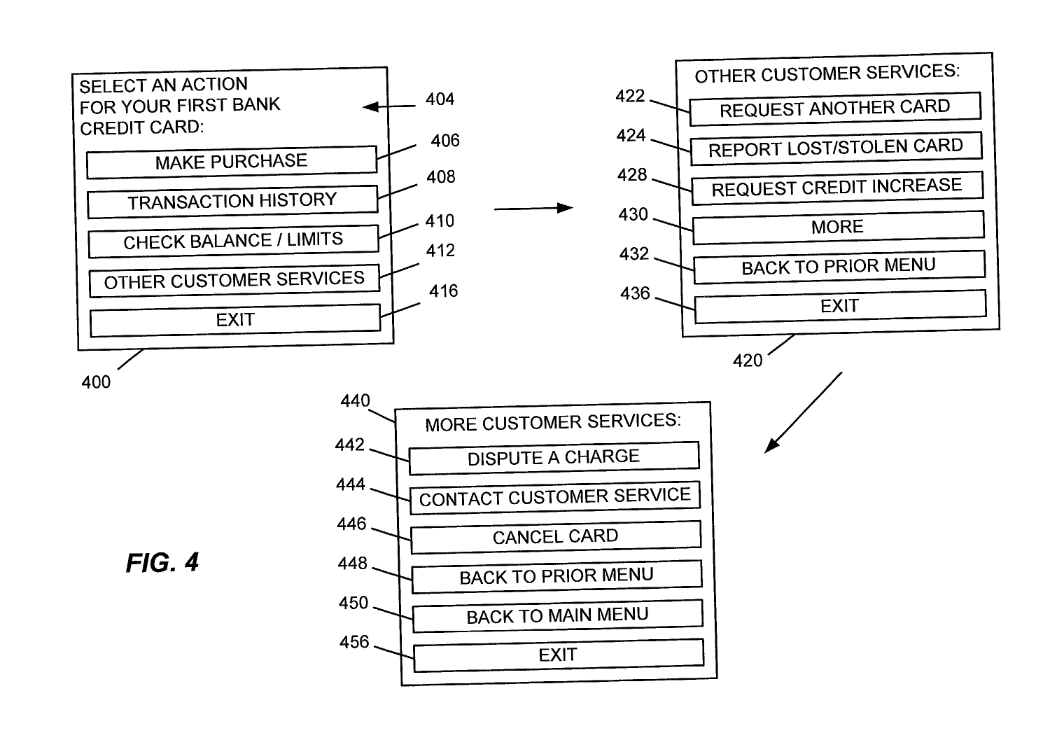

With reference to FIG. 4, an exemplary high-level menu system is provided for a conventional credit card as might be navigated at 350 of process 300. A highest level menu is illustrated as 400 in which the user is prompted for action at a top portion of the menu 404 and is given choices of five menu selections; 406, 408, 410, 412 and 416 from which to choose. In this illustration, the user can cause the menu 400 to appear by swiping a known credit card in card reader 190 (or alternatively, by making a selection from remote controller 36). The user can then choose to make a purchase at 406, obtain a transaction history at 408, check a credit balance or credit limit at 410, obtain additional customer services at 412 or exit at 416.

In the event the user elects to go to other customer services at 412, a sub-menu 420 appears listing several additional choices from which the user can select. In this example, the user can elect to request another credit card at 422, report a lost or stolen card at 424, request a credit limit increase at 428, explore more options at 430, go back to the prior menu at 432 or exit at 436. In the event the user selects more at 430 in menu 420, a lower level menu 440 appears. In this menu the user can elect to dispute a charge at 442, contact customer service at 444, cancel a credit card at 446, navigate to a prior menu at 448, go back to the main menu at 450 or exit entirely at 456. If 448 is selected, the user is taken back to menu 420. If 450 is selected the user is taken back to main menu 400.

Similarly, if 432 is selected from menu 420, the user is taken back to main menu 400.

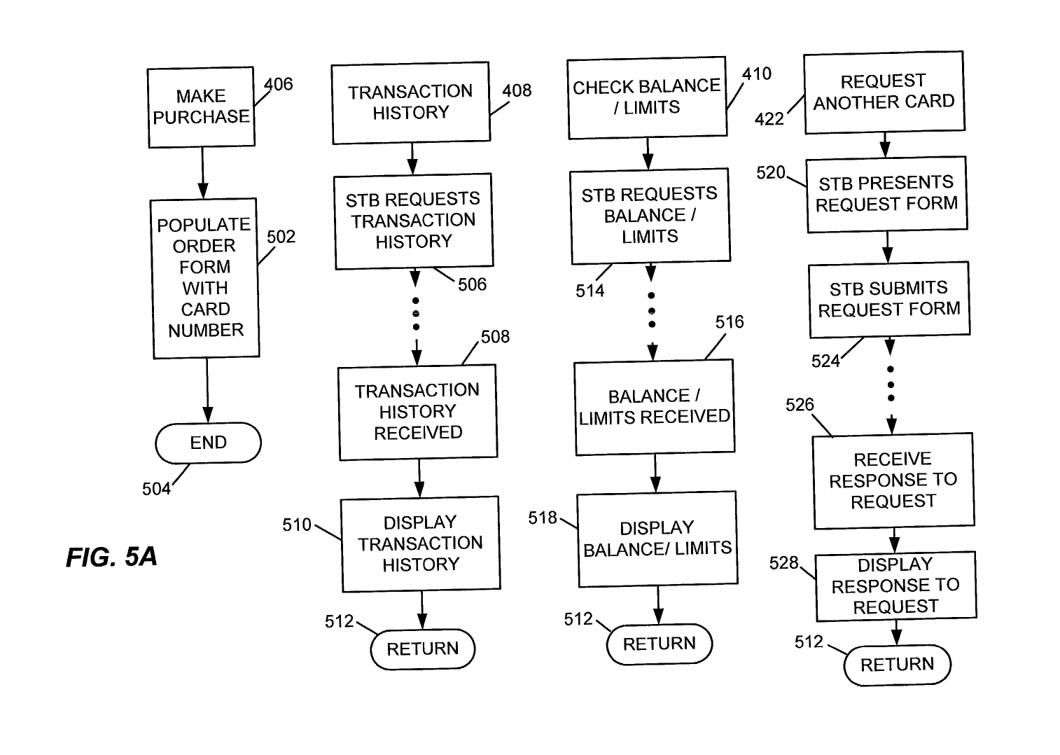

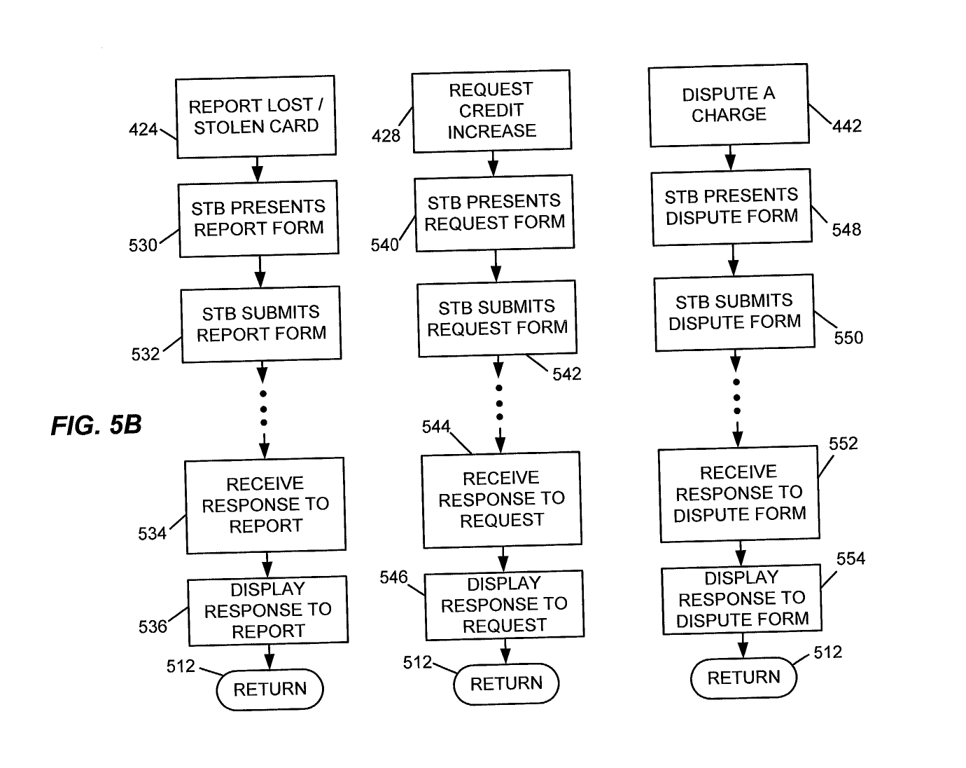

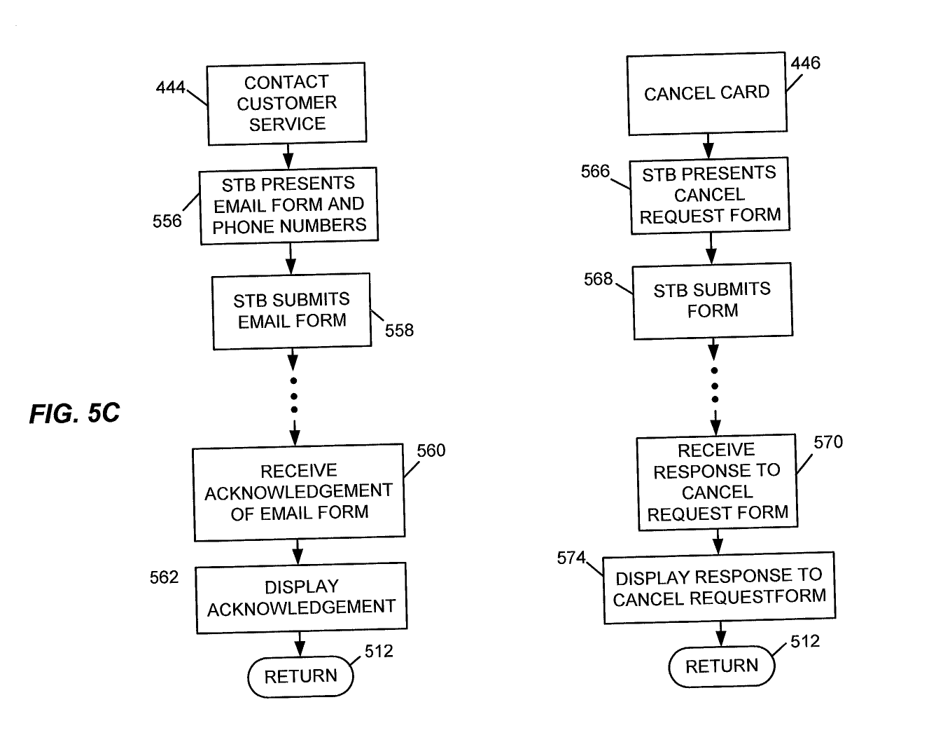

Depending upon the functions implemented in any particular swipe card issuers environment, the various menu selections (other than the navigational selections 416,432,436,448,450 and 456) available will vary. However, FIG. 5, made up of FIGS. 5A, 5B and 5C, provides one example of the actions that can be taken as a result of the various transactional menu selections for an actual credit card. In general, for most menu selections the selection will simply result in presenting the user with an appropriate form if necessary, for example an HTML form, to provide more detailed information relating to the request and this form is forwarded to the remote server 60. Remote server 60 then acts upon the message received and returns an acknowledgment or information relating to the transaction.

In the event menu selection 406 is made by the user, it is presumed that the user is in the process of making an online purchase, for example, through online merchant 48 via the Internet at the time the credit card is swiped. In this manner the central processor 132 of set-top box 22 is able to automatically populate the order form with credit card number and other appropriate information at 502 and the process ends at 504.

In the event the transaction history 408 is selected from menu 400, the set-top box forwards the information necessary to retrieve a transaction history at 506 including authenticating information to be used by the server 60. This communication corresponds with that of 358 of process 300 (once the authentication process 362 is carried out and the clearing house takes the appropriate action at 366 and returns a response to the user at 370) the transaction history can then be received by the set-top box at 508 and displayed to the user at 510 before returning at 512, for example, to the main menu 400 to present the user with an opportunity to carry out another transaction. In other embodiments the process can simply terminate and be restarted by the user swiping the credit card in swipe card reader 190 again.

In the event the user elects to check the balance or limits on the credit card at 410 the set-top box generates a request at 514 and sends the request to the remote server 60. The set-top box later receives the balance and limits information requested at 516 and displays the balance and limits at 518 before returning at 512. In general, the process for obtaining transaction history and balances and limits can be greatly simplified as shown since the set-top box may have all of the information needed for processing the requests without requesting additional information from the user. In a variation on this process, the transaction history can be constrained by functions such as a range in time in which case further input would be required from the user. Other variations will occur to those skilled in the art.

In the event the user wishes to request a new card at 422, the set-top box presents a request form at 520 for the user to complete. The request form may, for example, request the name of the potential user of the card and credit limit desired and may also request additional credit history information. Upon completion of the form, the set-top box submits the request form to the remote server 60 at 524. After the remote server 60 processes the request or receives the request, a response is returned to the set-top box at 526 for display at 528. The nature of the response may depend on a number of factors. For example, the response may simply provide an acknowledgment of the receipt of the request in the event the request is one which cannot be processed immediately. In other scenarios, the response may provide the user with an indication that the request has been approved or disapproved. Other variations will occur to those skilled in the art upon considering the nature of the various requests that can be handled by a system such as that of the present invention.

A similar process is carried out for the remaining selections that can be made by the user in menus 420 and 440. If a user elects to report a lost or stolen credit card at 424, the set-top box presents an appropriate form at 530 and submits the form to the remote server 60 when the user completes it. A response or acknowledgment is sent by the remote server and received at 534 and displayed at 536 to the user before the process returns at 512. Similarly, if the user elects to request a credit increase at 428, the set-top box presents an appropriate request form at 540 and then submits the request form after the user fills it out at 542. A response is received from remote server 60 at 544 and displayed to the user at 546 before returning at 512. In this example, a credit increase is likely to be an action that will require the credit card issuing company to analyze in greater detail before approving, and thus, the response displayed at 546 may simply be an acknowledgment of the receipt of the request with a confirmation or rejection of the request to follow by mail or e-mail.

If the user elects to dispute a charge at 442, the set-top box again presents an appropriate form for dealing with the dispute at 548. The user fills out the form and the set-top box submits the dispute form at 550 to the remote server 60. At 552 the set-top box receives a response to the dispute form from the remote server 60, which again is likely to be only an acknowledgment at this point, and the response is displayed to the user at 554 before returning at 512.

If the user elects to contact customer service at 444, the set-top box presents an e-mail form and other contact information such as phone numbers at 556. The user can then exit or elect to fill out the form and submit an inquiry by e-mail at 558 to the remote server 60. At 560 the set-top box 22 receives an acknowledgment of receipt of the e-mail form which is displayed to the user at 562. The process returns at 512. In the event the user elects to cancel the credit card at 446, the set-top box presents a cancel request form to the user at 566. The user completes the form and submits it at 568 to the remote server 60. At 570 the set-top box receives a response to the cancellation request form and response is displayed at 574 before the process returns at 512.

The exemplary embodiments illustrated above are not intended to be limiting of the various types of transactions that can be carried out using the swipe card reader 190 of set-top box 22 but are merely intended to be illustrative. Those skilled in the art will recognize that a similar array of transactions can be carried out for debit cards and automated teller cards used in conjunction with the swipe card reader 190 and set-top box 22 without departing from the present invention. For example, the process described, while suitable for a credit card, might not be suitable for debit card or automated teller card. In the case of other types of banking cards, the transaction carried out might include transfer of funds between accounts, request for automated bill payment, ordering checks, requesting a check to be issued by a banking institution, purchase of financial products such as certificates of deposits (CDs) or other conventional banking operations in a manner similar to that of an automated or conventional teller except for the lack of ability to deposit funds or receive cash on the spot.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent. The methods described herein can be stored as instructions to be carried out on a processor such as a computer on an electronic storage medium.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A television set-top box, comprising:
a tuner for receiving signals representing television programming and delivering the signals representing television programming to a display interface;
a central processor;
a communication device, operatively coupled to the central processor, suitable for sending and receiving data over a communication medium; and
a swipe card reader, operatively coupled to the central processor, to receive data from a swipe card passed through the swipe card reader.

2. The apparatus according to claim 1, further comprising storage means for storing data associated with the swipe card.

3. The apparatus according to claim 1, further comprising program means, operating on the programmed processor, for communicating information read from the swipe card to a credit card clearing house using the communication device.

4. The apparatus according to claim 1, further comprising program means, operating on the programmed processor, for communicating information read from the swipe card to a merchant using the communication device.

5. The apparatus according to claim 1, further comprising program means, operating on the programmed processor, for communicating information read from the swipe card to a swipe card issuing authority using the communication device.

6. The apparatus according to claim 1, further comprising program means, operating on the programmed processor, for receiving information regarding a credit card account in response to a transaction originating from the set-top box; the query including information relating to a swipe card passed through the swipe card reader.

7. The apparatus according to claim 1, wherein the swipe card comprises one of a credit card, an automated teller card and a debit card.

8. The apparatus according to claim 1, wherein the swipe card reader forms an integral part of the set-top box.

9. The apparatus according to claim 1, wherein the swipe card reader comprises an external swipe card reader coupled to the set-top box through a suitable interface.

10. A method of activating a swipe card using a set-top box having a swipe card reader associated therewith, the method comprising:
reading a magnetic stripe on the swipe card using the swipe card reader;
using communications capabilities of the set-top box, transmitting information read from the swipe card to an authority authorized to activate the swipe card; and
using communications capabilities of the set-top box, transmitting authentication information to the authority authorized to activate the swipe card.

11. The method according to claim 10, further comprising receiving a notice that the swipe card has been activated from the authority authorized to activate the swipe card.

12. The method according to claim 10, wherein the swipe card comprises one of a credit card, an automated teller card and a debit card.

13. The method according to claim 10, wherein the authority authorized to activate the swipe card comprises one of a swipe card activation/authentication clearing house and a swipe card issuer.

14. A method of carrying out a swipe card transaction using a television set-top box, comprising:
receiving a swipe card passed through a swipe card reader associated with the set-top box to read data associated with the swipe card;
retrieving authenticating information from a storage device associated with the set-top box; and
transmitting the data associated with the swipe card and the authenticating information using a communication device associated with the set-top box to a recipient.

15. The method according to claim 14, further comprising transmitting further authenticating information received from a user to the recipient.

16. The method according to claim 14, further comprising transmitting a query relating to an account associated with the swipe card to the recipient.

17. The method according to claim 14, further comprising transmitting a purchase using an account associated with the swipe card to the recipient.

18. The method according to claim 14, further comprising receiving a notice that the swipe card has been activated from the recipient.

19. The method according to claim 14, further comprising receiving a notice that a transaction associated with the swipe card has been authorized from the recipient.

20. The method according to claim 14, wherein the swipe card comprises one of a credit card, an automated teller card and a debit card.

21. The method according to claim 14, wherein the recipient comprises one of a swipe card activation/authentication clearing house and a swipe card issuer.

22. The method according to claim 14, wherein the transaction comprises one of making a purchase, retrieving a transaction history, checking an account balance, checking a credit limit, requesting an additional swipe card, reporting a lost/stolen card, requesting a credit limit increase, disputing a charge, sending a message to a customer service organization, cancelling a card and transferring funds.

23. A storage medium storing instructions which, when executed on a programmed processor, carry out a process of activating a swipe card using a set-top box having a swipe card reader associated therewith, comprising:
reading a magnetic stripe on the swipe card using the swipe card reader;
using communications capabilities of the set-top box, transmitting information read from the swipe card to an authority authorized to activate the swipe card; and
using communications capabilities of the set-top box, transmitting authentication information to the authority authorized to activate the swipe card.

24. The storage medium according to claim 23, further comprising receiving a notice that the swipe card has been activated from the authority authorized to activate the swipe card.

25. A storage media storing instructions which, when executed on a programmed processor, carry out a method of carrying out a swipe card transaction using a television set-top box, comprising:
receiving a swipe card passed through a swipe card reader associated with the set-top box to read data associated with the swipe card;
retrieving authenticating information from a storage device associated with the set-top box; and
transmitting the data associated with the swipe card and the authenticating information using a communication device associated with the set-top box to a recipient.

26. The storage medium according to claim 25, further comprising transmitting further authenticating information received from a user to the recipient.

27. The storage medium according to claim 25, further comprising transmitting a query relating to an account associated with the swipe card to the recipient.

28. The storage medium according to claim 25, further comprising transmitting a purchase using an account associated with the swipe card to the recipient.

29. The storage medium according to claim 25, further comprising receiving a notice that the swipe card has been activated from the recipient.

30. The storage medium according to claim 25, further comprising receiving a notice that a transaction associated with the swipe card has been authorized from the recipient.
